(19) United States
(12) Patent Application Publication
(10) Pub. No.: US 2017/0032479 A1
(43) Pub. Date: Feb. 2, 2017

(54) METHOD AND DEVICE FOR FLIGHT NOTIFICATION AND SETTING

(71) Applicant: Xiaomi Inc., Beijing (CN)

(72) Inventors: Liangxiong WU, Beijing (CN); Liang ZHANG, Beijing (CN); Ming LIU, Beijing (CN)

(73) Assignee: Xiaomi Inc.

(21) Appl. No.: 15/218,813

(22) Filed: Jul. 25, 2016

(30) Foreign Application Priority Data
Jul. 31, 2015 (CN) 201510463639.8

(51) Int. Cl. G06Q 50/14; H04L 12/58; H04L 29/08

(52) U.S. Cl. CPC G06Q 50/14; H04L 67/26; H04L 67/20; H04L 51/38

(57) ABSTRACT

A method for flight notification includes receiving flight setting information including a flight and at least one contact, monitoring flight information corresponding to the flight, generating a flight change notification according to change information associated with a change in the flight information when the flight information indicates the change in the flight, and sending the flight change notification to the at least one contact. The flight information is provided by an airline server. The flight change notification includes the change information.

### CROSS-REFERENCE TO RELATED APPLICATION

This application is based upon and claims priority to Chinese Patent Application No. 201510463639.8, filed Jul. 31, 2015, the entire contents of which are incorporated herein by reference.

### TECHNICAL FIELD

The present disclosure generally relates to network communication and, more particularly, to a method and device for flight notification and setting.

### BACKGROUND

Sometimes people need to notify a contact regarding changes of a flight taken by the user. In conventional technologies, the contact may, for example, use an app developed by the airline company to obtain the flight information, or check the flight information from a large screen at the airport. However, if the contact does not have the app or does not check the flight information in time, the contact may miss the changes in the flight information.

### SUMMARY

In accordance with the present disclosure, there is provided a method for flight notification including receiving flight setting information including a flight and at least one contact, monitoring flight information corresponding to the flight, generating a flight change notification according to change information associated with a change in the flight information when the flight information indicates the change in the flight, and sending the flight change notification to the at least one contact. The flight information is provided by an airline server. The flight change notification includes the change information.

In accordance with the present disclosure, there is also provided a method for flight setting including determining whether flight setting information is received, and sending the flight setting information to a user server when determining that the flight setting information is received. The flight setting information includes a flight and at least one contact.

In accordance with the present disclosure, there is also provided a device for flight notification including a processor and a memory storing instructions. The instructions, when executed by the processor, cause the processor to receive flight setting information including a flight and at least one contact, monitor flight information corresponding to the flight, generate a flight change notification according to change information associated with a change in the flight information when the flight information indicates the change in the flight, and send the flight change notification to the at least one contact. The flight information is provided by an airline server. The flight change notification includes the change information.

In accordance with the present disclosure, there is also provided a device for flight setting including a processor and a memory storing instructions. The instructions, when executed by the processor, cause the processor to determine whether flight setting information is received, and send the flight setting information to a user server when determining that the flight setting information is received. The flight setting information includes a flight and at least one contact.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart showing a method for flight notification according to an exemplary embodiment of the present disclosure.

FIG. 2 is a flowchart showing an example of monitoring flight information in the method shown in FIG. 1.

FIG. 3 is a flowchart showing an example of generating a flight change notification in the method shown in FIG. 1.

FIG. 4 is a flowchart showing a method for flight setting according to an exemplary embodiment of the present disclosure.

FIG. 5 is a flowchart showing an example of determining whether flight setting information is received in the method shown in FIG. 4.

FIG. 6 is a schematic diagram showing a flight change notification template according to an exemplary embodiment of the present disclosure.

FIG. 7 is a block diagram showing a device for flight notification according to an exemplary embodiment of the present disclosure.

FIG. 8 is a block diagram showing an example of a change notification generating module of the device shown in FIG. 7.

FIG. 9 is a block diagram showing another example of the change notification generating module.

FIG. 10 is a block diagram showing an example of a monitoring module of the device shown in FIG. 7.

FIG. 11 is a block diagram showing a device for flight notification according to another exemplary embodiment of the present disclosure.

FIG. 12 is a block diagram showing a device for flight setting according to an exemplary embodiment of the present disclosure.

FIG. 13 is a block diagram showing an example of a determination module of the device shown in FIG. 12.

FIG. 14 is a block diagram showing a user server for flight notification according to an exemplary embodiment of the present disclosure.

FIG. 15 is a block diagram showing a terminal for flight setting according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

The terminology used in the description of the disclosure herein is for the purpose of describing particular examples only and is not intended to limit the disclosure. As used in the description of the disclosure and the appended claims, the singular form articles “a” and “an” are intended to also include the plural forms, unless the context clearly indicates otherwise. It will also be understood that the term “and/or” as used herein refers to and encompasses any and all possible combinations of one or more of the associated listed items.

Although the present disclosure uses terms such as “first,” “second,” and “third” to describe various information, the information is not be limited by these terms. Using these terms is only for distinguishing information of the same type. For example, without departing from the scope of the present disclosure, the first information may be referred to as the second information, and similarly, the second information may be referred to as the first information. Depending on the context, the term “if” used herein may be interpreted as “when” or “in response to determining that . . . ”.

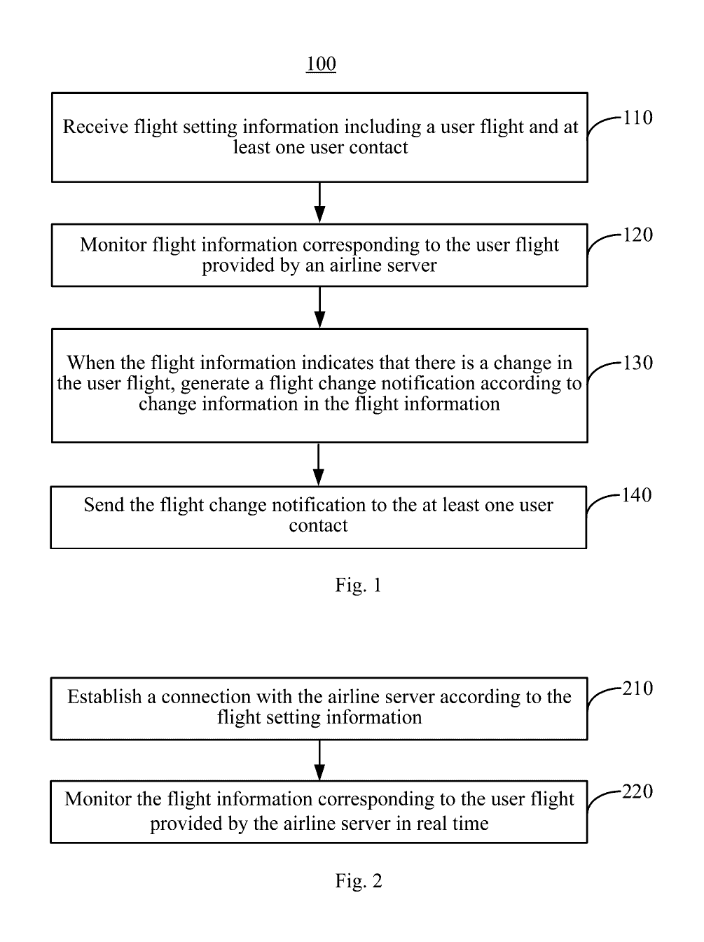

FIG. 1 is a flowchart showing a method 100 for flight notification according to an exemplary embodiment of the present disclosure. The method 100 can be implemented, for example, in a server. Hereinafter, the server in which a method consistent with the present disclosure is implemented is also referred to as a “user server.” As shown in FIG. 1, at 110, information for setting flight notification is received. In this disclosure, setting flight notification is also referred to as “flight setting” and the information for setting flight notification is also referred to as “flight setting information.” The flight setting information includes a flight of a user, also referred to herein as a “user flight,” and at least one contact of the user, where a contact of the user is also referred to herein as a “user contact.”

In some embodiments, the flight setting information can be set by the user, and the user flight can be a flight to be taken by the user. In some embodiments, the flight setting information is sent through a terminal, and the user can be the owner of the terminal or another person. In some embodiments, the flight information can be provided using a template, which the user can choose to edit to obtain the flight information or to use directly as the flight information. For example, one or more templates can be provided, and the user can select one of the one or more templates and edit the selected template to obtain the flight information or directly use the selected template as the flight setting information. The at least one user contact can be a person to pick up the user, or can be a family member or a friend of the user. In some embodiments, the user contact can be recorded using contact information of the user contact, such as a telephone number, an email address, a QQ number, or a WeChat number of the user contact.

In some embodiments, in addition to the user flight and the at least one user contact, the flight setting information can include user defined information, such as “I am Xiaoming, the flight changes and is estimated to arrive at about_. Please don't worry.” The “_” is a placeholder. After the user server obtains an updated arrival time, the user server can fill the updated arrival time at the position corresponding to the placeholder.

At 120, flight information corresponding to the user flight provided by an airline server is monitored. In some embodiments, the user server and the airline server can be different servers. The airline server provides information of various flights including, for example, flight numbers, departure times, arrival times, and the like. When the user server receives the flight setting information from the terminal, the user server monitors the flight information corresponding to the user flight provided by the airline server according to the user flight in the flight setting information, to determine whether the user flight has changed.

At 130, when the flight information indicates that there is a change in the user flight, a flight change notification is generated according to change information in the flight information corresponding to the user flight. The flight change notification includes the change information. For example, the change information can include flight delay, airplane malfunction, or change of arriving airport due to the weather. If the flight information includes the change information, the flight change notification is generated to indicate that there is a change in the user flight, and the generated flight change notification includes the change information. If the user flight is delayed, the change information can include the updated arrival time. If the airplane needs to land at a different airport, the change information can include, for example, a name of that airport and an arrival time.

At 140, the flight change notification is sent to the at least one user contact. That is, when the flight information indicates that there is a change in the user flight, the user server actively sends the flight change notification to the at least one user contact, so that the at least one user contact can manage time according to the change information.

FIG. 2 is a flow chart showing an example of monitoring the flight information, i.e., process 120 in the method 100. As shown in FIG. 2, at 210, a connection with the airline server is established according to the flight setting information. At 220, the flight information corresponding to the user flight provided by the airline server is monitored in real time. If a change in the flight information occurs, a notification is generated. Otherwise, no notification needs to be generated.

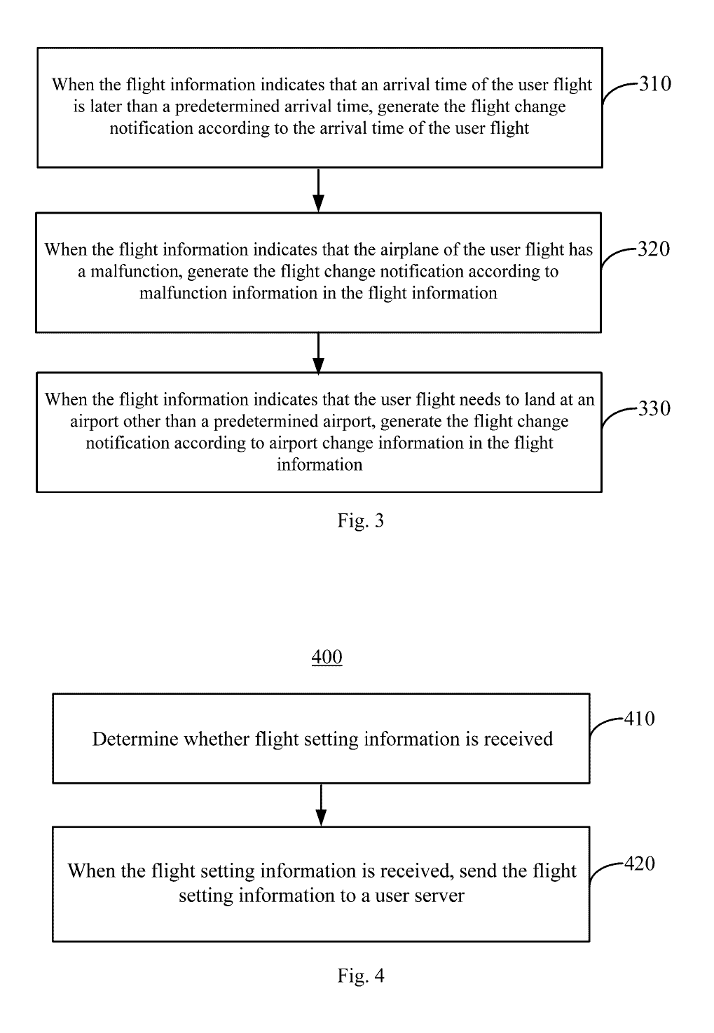

FIG. 3 is a flow chart showing an example of generating the flight change notification, i.e., process 130 in the method 100. As shown in FIG. 3, at 310, when the flight information indicates that an arrival time of the user flight is later than a predetermined arrival time, the flight change notification is generated according to the arrival time of the user flight. The flight change notification includes the changed arrival time of the user flight.

At 320, when the flight information indicates that the airplane of the user flight has a malfunction, the flight change notification is generated according to the malfunction information in the flight information. The flight change notification includes the malfunction information.

At 330, when the flight information indicates that the user flight needs to land at an airport different from a predetermined airport, the flight change notification is generated according to airport change information in the flight information. The flight change notification includes a name of the airport at which the user flight is to land and an arrival time.

The above processes 310, 320, and 330 do not need to be performed in the above order. They can be performed in different orders or be performed simultaneously.

For example, if a malfunction occurs and the flight needs to land at an airport different from the predetermined airport, and the time when arriving at that airport is much later than the predetermined arrival time for arriving at the predetermined airport, the flight change notification can include, for example, the malfunction information, the name of the airport at which the flight is to land, and the updated arrival time.

As another example, if a malfunction occurs and the arrival time is much later than the predetermined arrival time, the flight change information can include, for example, the malfunction information and the updated arrival time.

In some embodiments, the received flight setting information includes a placeholder. In such embodiments, the flight change notification can be generated by filling the placeholder according to the monitored change information in the flight information.

In some embodiments, the flight change notification can be sent to the at least one user contact via short message, email, or an instant messaging application. The instant messaging application can be, for example, WeChat, QQ, or MiTalk.

In some embodiments, after monitoring the flight information corresponding to the user flight provided by the airline server is performed and the flight information indicates no change, the flight setting information is deleted. For example, if the user flight arrives on time, the flight setting information set by the user can be deleted without a flight change notification being sent to the user contact.

Alternatively, instead of not sending any notification, a notification different from the above flight change notification can be set and sent to the at least one user contact when there is no change in the flight information.

FIG. 4 is a flowchart showing a method 400 for flight setting according to an exemplary embodiment of the present disclosure. The method 400 can be implemented, for example, in a terminal, such as a smart phone, a tablet computer, or a personal computer.

As shown in FIG. 4, at 410, whether flight setting information is received is determined. The flight setting information includes a user flight and at least one user contact. The flight setting information in the method 400 is similar to the flight setting information in the method 100 described above with reference to FIGS. 1-3, and thus its detailed description is omitted here.

At 420, when it is determined that the flight setting information is received, the flight setting information is sent to a user server, so that the user server monitors flight information provided by an airline server that corresponds to the user flight in the flight setting information.

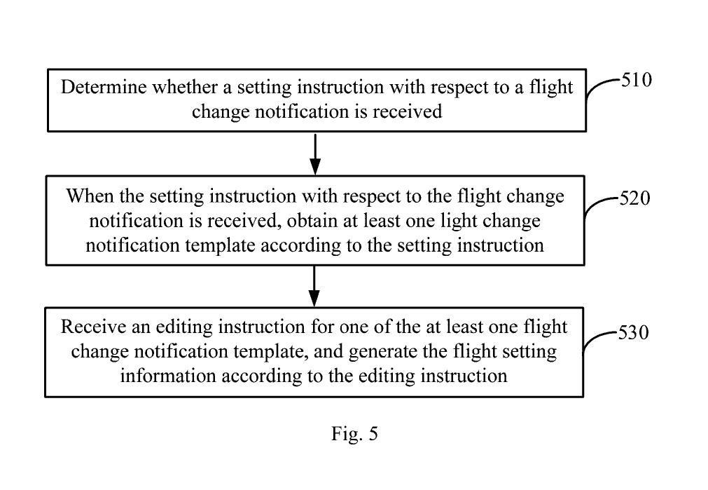

FIG. 5 is a flow chart showing an example of determining whether the flight setting information is received, i.e., process 410 in the method 400. As shown in FIG. 5, at 510, whether a setting instruction with respect to a flight change notification is received is determined. At 520, when the setting instruction with respect to the flight change notification is received, at least one flight change notification template is obtained according to the setting instruction. At 530, an editing instruction for one of the at least one flight change notification template is received, and the flight setting information is generated according to the editing instruction.

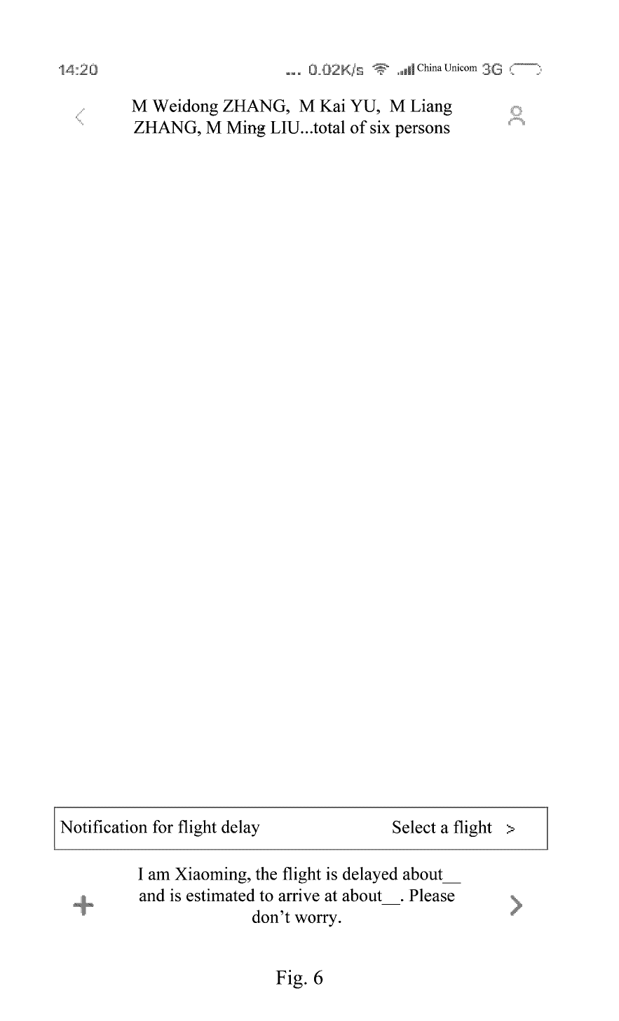

In some embodiments, a flight change notification template includes at least one reserved placeholder in which flight information corresponding to the user flight can be filled. FIG. 6 shows an exemplary flight change notification template including two reserved placeholders. As shown in FIG. 6, the template is as follows: “I am Xiaoming, the flight is delayed for about and is estimated to arrive at about_. Please don't worry”. The underlines “_” are placeholders. Thus, after the user server obtains the flight information, the user server can fill the delayed time and the updated arrival time at the positions corresponding to the placeholders.

In some embodiments, a flight change setting function can be provided through short messages. The user can select the flight change setting function, select the flight to take, and set the contact information of the pick-up person, a family member, or a friend to be informed if the flight changes. After customization is completed, the user submits the flight setting information to the user server.

In some embodiments, the flight setting information can be sent to the user server through at least one of a short message, an email, an instant messaging application. The instant messaging application can be, for example, WeChat, QQ, or MiTalk.

Exemplary devices for flight notification and flight setting consistent with the present disclosure are described below.

FIG. 7 is a block diagram showing a device 700 for flight notification according to an exemplary embodiment of the present disclosure. The device 700 can be implemented, for example, in a user server and is configured to perform a method for flight notification consistent with the present disclosure, such as the method 100 shown in FIG. 1. The device 700 includes a receiving module 701, a monitoring module 702, a change notification generating module 703, and a sending module 704. The receiving module 701 is configured to receive flight setting information including a user flight and at least one user contact. The monitoring module 702 is configured to monitor flight information corresponding to the user flight provided by an airline server. The change notification generating module 703 is configured to, when the flight information indicates that there is a change in the user flight, generate a flight change notification according to change information in the flight information. The flight change notification includes the change information. The sending module 704 is configured to send the flight change notification to the at least one user contact.

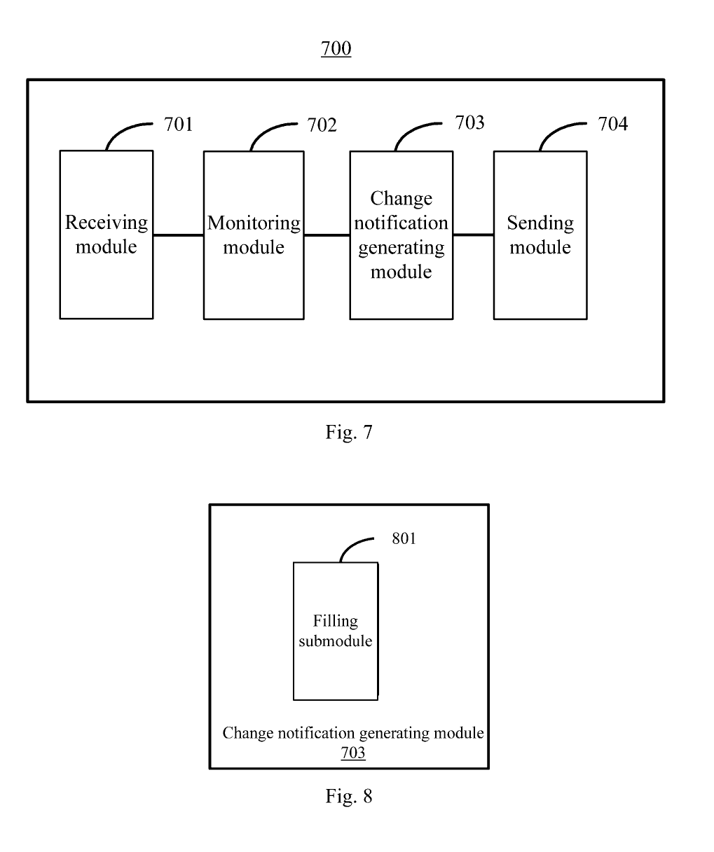

FIG. 8 is a block diagram showing an example of the change notification generating module 703. As shown in FIG. 8, the change notification generating module 703 includes a filling submodule 801 configured to fill a placeholder in the flight setting information according to the change information in the flight information to generate the flight change notification.

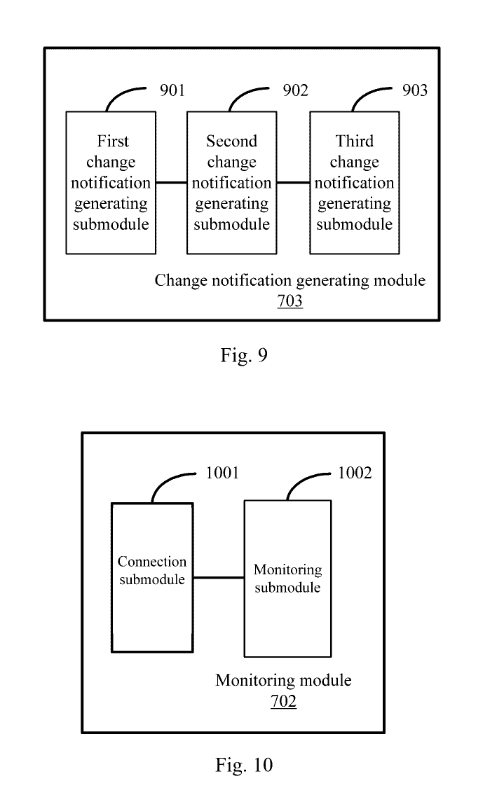

FIG. 9 is a block diagram showing another example of the change notification generating module 703. As shown in FIG. 9, the change notification generating module 703 includes a first change notification generating submodule 901, or a second change notification generating submodule 902, or a third change notification generating submodule 903.

The first change notification generating submodule 901 is configured to, when the flight information indicates that an arrival time of the user flight is later than a predetermined arrival time, generate the flight change notification according to the arrival time of the user flight. The flight change notification includes the arrival time after the user flight changes.

The second change notification generating submodule 902 is configured to, when the flight information indicates that airplane of the user flight has a malfunction, generate the flight change notification according to malfunction information in the flight information. The flight change notification includes the malfunction information.

The third change notification generating submodule 903 is configured to, when the flight information indicates that the user flight needs to land at an airport different from a predetermined airport, generate the flight change notification according to airport change information in the flight information. The flight change notification includes a name of the airport at which the flight is to land and an arrival time.

FIG. 10 is a block diagram showing an example of the monitoring module 702. As shown in FIG. 10, the monitoring module 702 includes a connection submodule 1001 and a monitoring submodule 1002. The connection submodule 1001 is configured to establish a connection with the airline server according to the flight setting information. The monitoring submodule 1002 is configured to monitor the flight information corresponding to the user flight provided by the airline server in real time.

In some embodiments, the sending module 704 is configured to send the flight change notification to each of the at least one user contact via at least one of a short message, an email, or an instant messaging application.

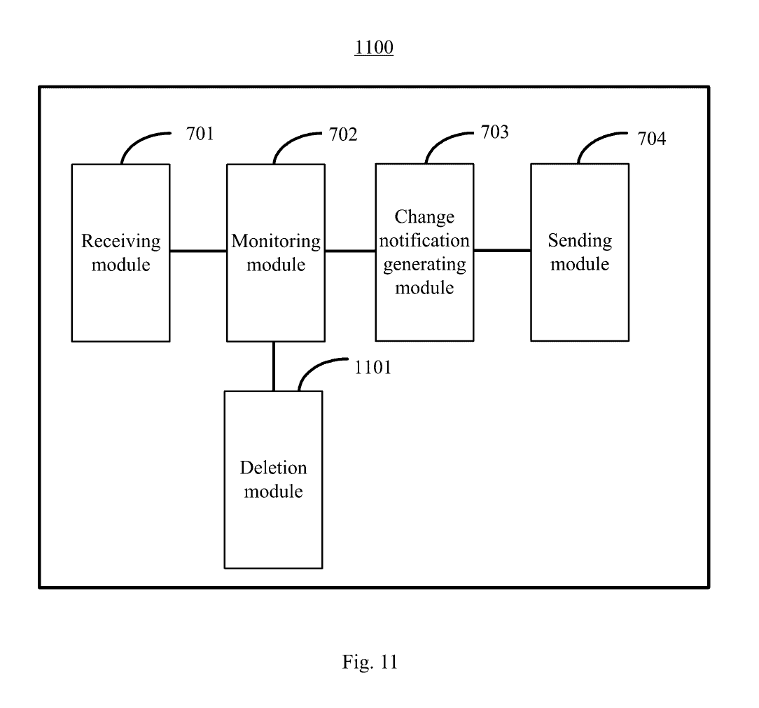

FIG. 11 is a block diagram showing a device 1100 for flight notification according to another exemplary embodiment of the present disclosure. The device 1100 is similar to the device 700, except that the device 1100 further includes a deletion module 1101. The deletion module 1101 is configured to, when the flight information indicates that there is no change in the user flight, delete the flight setting information.

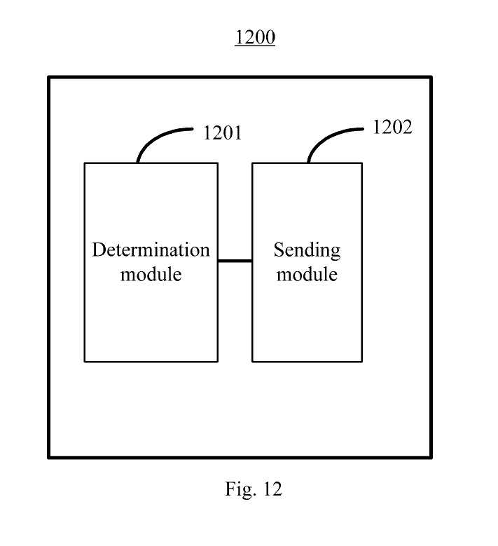

FIG. 12 is a block diagram showing a device 1200 for flight setting according to an exemplary embodiment of the present disclosure. The device 1200 can be implemented, for example, in a terminal. As shown in FIG. 12, the device 1200 includes a determination module 1201 and a sending module 1202.

The determination module 1201 is configured to determine whether flight setting information is received. The flight setting information includes a user flight and at least one user contact.

The sending module 1202 is configured to, when it is determined that the flight setting information is received, send the flight setting information to a user server, so that the user server monitors flight information corresponding to the user flight provided by an airline server.

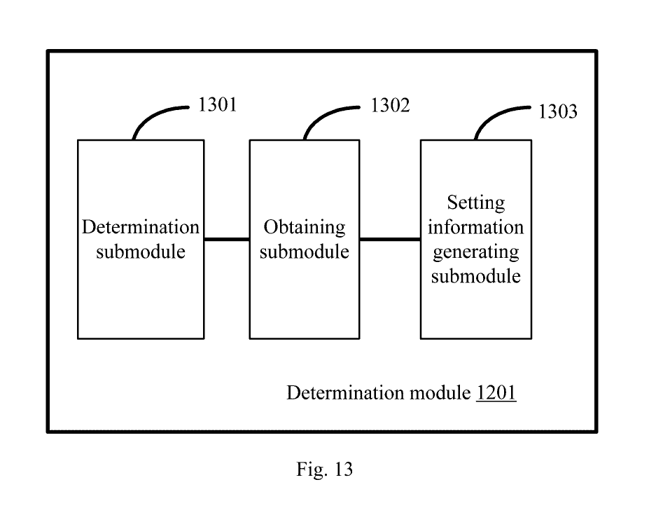

FIG. 13 is a block diagram showing an example of the determination module 1201. As shown in FIG. 13, the determination module 1201 includes a determination submodule 1301, an obtaining submodule 1302, and a setting information generating submodule 1303. The determination submodule 1301 is configured to determine whether a setting instruction with respect to a flight change notification is received. The obtaining submodule 1302 is configured to, when the setting instruction with respect to the flight change notification is received, obtain at least one flight change notification template according to the setting instruction. The setting information generating submodule 1303 is configured to receive an editing instruction for one of the at least one flight change notification template, and generate the flight setting information according to the editing instruction. A flight change notification template includes at least one reserved placeholder in which flight information corresponding to the flight of the user is to be filled.

In some embodiments, the sending module 1202 is configured to send the flight setting information to the user server via at least one of a short message, an email, or an instant messaging application.

Operations of the above-described exemplary devices are similar to the exemplary methods described above, and thus their detailed description is omitted here. The above described embodiments of devices are only illustrative, and portions described as separated units may be or may not be physically separated, and the portions shown as respective units may be or may not be physical units, i.e., the portions may be located at one place, or may be distributed over a plurality of network units. A part or whole of the modules may be selected to realize the objectives of the technical solutions of the present disclosure according to actual requirements. One of ordinary skill in this art can understand and practice the technical solutions of the present disclosure.

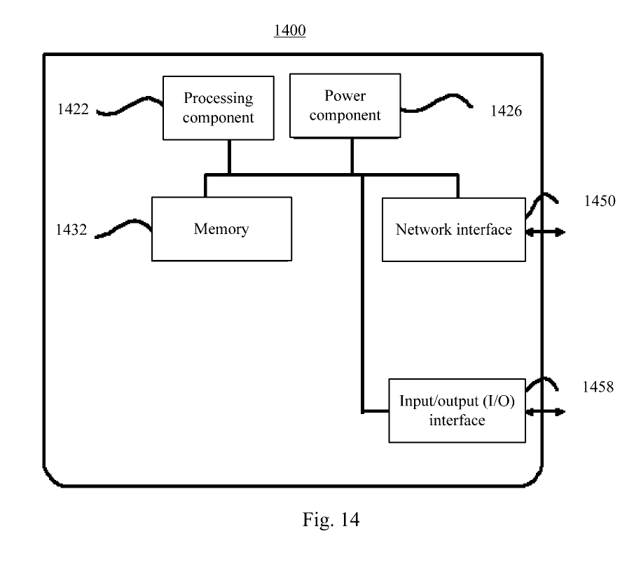

FIG. 14 is a block diagram showing a user server 1400 for flight notification according to an exemplary embodiment. For example, the user server 1400 includes a processing component 1422 that further includes one or more processors, and memory resources represented by a memory 1432 for storing instructions executable by the processing component 1422, such as application programs. The application programs stored in the memory 1432 may include one or more modules each corresponding to a set of instructions. Further, the processing component 1422 is configured to execute the instructions.

The user server 1400 also includes a power component 1426 configured to perform power management of the user server 1400, wired or wireless network interface(s) 1450 configured to connect the user server 1400 to a network, and an input/output (I/O) interface 1458. The user server 1400 may operate based on an operating system stored in the memory 1432, such as Windows Server™ Mac OS X™ Unix, Linux™, FreeBSD™, or the like.

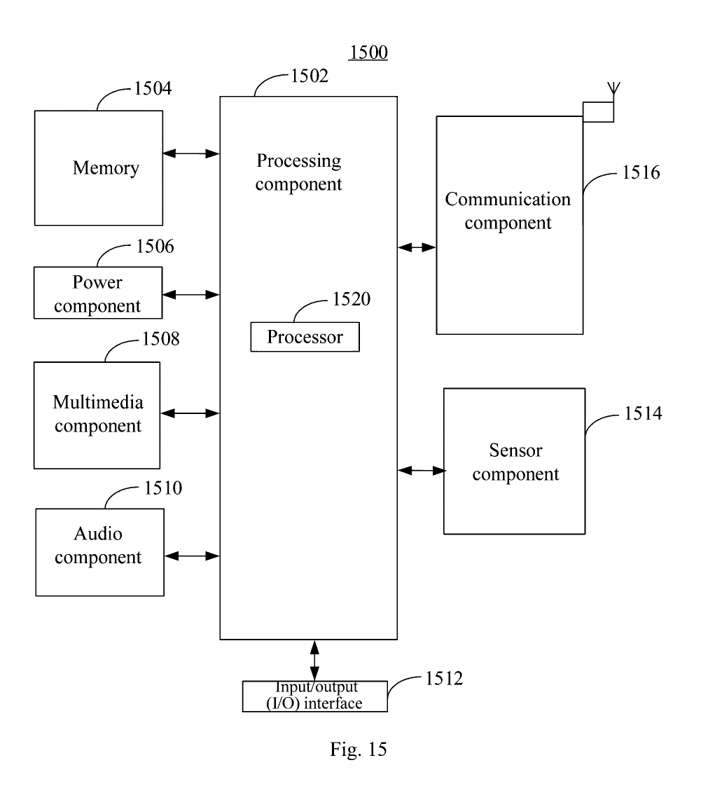

FIG. 15 is a block diagram showing a terminal 1500 for flight setting according to an exemplary embodiment of the present disclosure. For example, the terminal 1500 may be a mobile phone, a computer, a digital broadcast terminal, a messaging device, a gaming console, a tablet, a medical device, exercise equipment, a personal digital assistant, or the like.

Referring to FIG. 15, the terminal 1500 includes one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the terminal 1500, such as the operations associated with display, telephone calls, data communications, camera operations, and recording operations. The processing component 1502 may include one or more processors 1520 to execute instructions to perform all or part of a method consistent with the present disclosure, such as one of the above-described exemplary methods. Moreover, the processing component 1502 may include one or more modules which facilitate the interaction between the processing component 1502 and other components. For example, the processing component 1502 may include a multimedia module to facilitate the interaction between the multimedia component 1508 and the processing component 1502.

The memory 1504 is configured to store various types of data to support the operation of the terminal 1500. Examples of such data include instructions for any applications or methods operated on the terminal 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the terminal 1500. The power component 1506 may include a power management system, one or more power sources, and any other components associated with the generation, management, and distribution of power in the terminal 1500.

The multimedia component 1508 includes a screen providing an output interface between the terminal 1500 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the terminal 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone configured to receive an external audio signal when the terminal 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the terminal 1500. For example, the sensor component 1514 may detect an open/closed status of the terminal 1500, relative positioning of components, e.g., the display and the keypad, of the terminal 1500, a change in position of the terminal 1500 or a component of the terminal 1500, a presence or absence of user contact with the terminal 1500, an orientation or an acceleration/deceleration of the terminal 1500, and a change in temperature of the terminal 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, a microwave sensor, or a temperature sensor.

The communication component 1516 is configured to facilitate communication, wired or wirelessly, between the terminal 1500 and other devices. The terminal 1500 can access a wireless network based on a communication standard, such as WiFi, 2G, 3G, or 4G or a combination thereof. In one exemplary embodiment, the communication component 1516 receives a broadcast signal or broadcast associated information from an external broadcast management system via a broadcast channel. In one exemplary embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

In exemplary embodiments, the terminal 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method consistent with the present disclosure, such as one of the above-described exemplary methods.

In exemplary embodiments, there is also provided a non-transitory computer-readable storage medium including instructions, such as included in the memory 1504, executable by the processor 1520 in the terminal 1500, or included in the memory 1432, executable by the processing component 1422 in the user terminal 1400, for performing a method consistent with the present disclosure, such as one of the above-described exemplary methods. For example, the non-transitory computer-readable storage medium may be a ROM, a

RAM, a CD-ROM, a magnetic tape, a floppy disc, an optical data storage device, or the like.

In exemplary embodiments, there is also provided a device including a processor and a memory storing instructions that, when executed by the processor, cause the processor to perform a method consistent with the present disclosure, such as one of the above-described exemplary methods.

According to the present disclosure, when a flight of a user is changed, contacts of the user can be timely notified. Therefore, user experience is improved.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present invention is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for flight notification, comprising:
receiving flight setting information including a flight and at least one contact;
monitoring flight information corresponding to the flight, the flight information being provided by an airline server;
generating, when the flight information indicates a change in the flight, a flight change notification according to change information associated with the change in the flight information, the flight change notification including the change information; and
sending the flight change notification to the at least one contact.

2. The method according to claim 1, wherein:
the flight setting information further includes a placeholder;
generating the flight change notification includes filling the placeholder according to the change information to generate the flight change notification.

3. The method according to claim 1, wherein generating the flight change notification includes at least one of:
generating, when the flight information indicates that an updated arrival time of the flight is later than a predetermined arrival time, the flight change notification according to the updated arrival time, the flight change notification including the updated arrival time; or
generating, when the flight information indicates that the flight encounters a malfunction, the flight change notification according to malfunction information in the flight information, the flight change notification including the malfunction information; or
generating, when the flight information indicates that the flight needs to land at a new airport different from a predetermined airport, the flight change notification according to airport change information in the flight information, the flight change notification including a name of the new airport and an arrival time.

4. The method according to claim 1, wherein sending the flight change notification to the at least one contact includes sending the flight change notification to the at least one contact via at least one of a short message, an email, or an instant messaging application.

5. The method according to claim 1, further comprising:
deleting, when the flight information indicates that there is no change in the flight, the flight setting information.

6. A method for flight setting, comprising:
determining whether flight setting information is received, the flight setting information including a flight and at least one contact; and
sending, when determining that the flight setting information is received, the flight setting information to a user server.

7. The method according to claim 6, wherein determining whether the flight setting information is received includes:
obtaining, when a setting instruction with respect to a flight change notification is received, at least one flight change notification template according to the setting instruction;
receiving an editing instruction for one of the at least one flight change notification template; and
generating the flight setting information based on the one of the at least one flight change notification template according to the editing instruction.

8. The method according to claim 7, wherein obtaining the at least one flight change notification template includes obtaining a flight change notification template having a reserved placeholder for filling in flight information corresponding to the flight.

9. The method according to claim 6, wherein sending the flight setting information to the user server includes sending the flight setting information to the user server via at least one of a short message, an email, or an instant messaging application.

10. A device for flight notification, comprising:
a processor; and
a memory storing instructions that, when executed by the processor, cause the processor to:
receive flight setting information including a flight and at least one contact;
monitor flight information corresponding to the flight, the flight information being provided by an airline server;
generate, when the flight information indicates a change in the flight, a flight change notification according to change information associated with the change in the flight information, the flight change notification including the change information; and
send the flight change notification to the at least one contact.

11. The device according to claim 10, wherein:
the flight setting information further includes a placeholder, and the instructions further cause the processor to:
fill the placeholder according to the change information to generate the flight change notification.

12. The device according to claim 10, wherein the instructions further cause the processor to perform at least one of:
generating, when the flight information indicates that an updated arrival time of the flight is later than a predetermined arrival time, the flight change notification according to the updated arrival time, the flight change notification including the updated arrival time; or
generating, when the flight information indicates that the flight encounters a malfunction, the flight change notification according to malfunction information in the flight information, the flight change notification including the malfunction information; or
generating, when the flight information indicates that the flight needs to land at a new airport different from a predetermined airport, the flight change notification according to airport change information in the flight information, the flight change notification including a name of the new airport and an arrival time.

13. The device according to claim 10, wherein instructions further cause the processor to:
send the flight change notification to the at least one contact via at least one of a short message, an email, or an instant messaging application.

14. The method according to claim 10, wherein the instructions further cause the processor to:
delete, when the flight information indicates that there is no change in the flight, the flight setting information.

15. A device for flight setting, comprising:
a processor; and
a memory storing instructions that, when executed by the processor, cause the processor to:
determine whether flight setting information is received, the flight setting information including a flight and at least one contact; and
send, when determining that the flight setting information is received, the flight setting information to a user server.

16. The device according to claim 15, wherein the instructions further cause the processor to:
obtain, when a setting instruction with respect to a flight change notification is received, at least one flight change notification template according to the setting instruction;
receive an editing instruction for one of the at least one flight change notification template; and
generate the flight setting information based on the one of the at least one flight change notification template according to the editing instruction.

17. The device according to claim 16, wherein the instructions further cause the processor to:
Obtain a flight change notification template having a reserved placeholder for filling in flight information corresponding to the flight.

18. The device according to claim 15, wherein the instructions further cause the processor to send the flight setting information to the user server via at least one of a short message, an email, or an instant messaging application.
